(19) United States
(12) Patent Application Publication
(10) Pub. No.: US 2025/0322666 A1
(43) Pub. Date: Oct. 16, 2025

(54) Method for Calibrating the Position of a Marking on a Vehicle

(71) Applicant: Robert Bosch GmbH, Stuttgart (DE)

(72) Inventors: Mate Fugerth, Budapest (HU); Imre Benedek Juhasz, Budapest (HU); Nelli Nyisztor, Budapest (HU); Zsombor Pancsics, Budapest (HU)

(21) Appl. No.: 19/171,221

(22) Filed: Apr. 5, 2025

(30) Foreign Application Priority Data
Apr. 11, 2024 (DE) 10 2024 203 338.3

(51) Int. Cl. G06V 20/54; G06T 7/73; G06V 20/17

(52) U.S. Cl. CPC G06V 20/54; G06T 7/73; G06V 20/17; G06V 2201/07

(57) ABSTRACT

A method for calibrating the position of a marking on a vehicle suitable for detecting the position of the vehicle in video data is disclosed. The method includes (a) applying the marking to the vehicle, (b) applying test markers on both sides of a rear axle of the vehicle, (c) creating at least one image of the vehicle with the marking and the test markers, (d) detecting the position of the test markers in a coordinate system based on the at least one image, (e) detecting the position of the marking in the coordinate system based on the at least one image, and (f) calculating the relative position of the marking to the test markers.

This application claims priority under 35 U.S.C. § 119 to application no. DE 10 2024 203 338.3, filed on Apr. 11, 2024 in Germany, the disclosure of which is incorporated herein by reference in its entirety.

### BACKGROUND

Correctly detecting the environment around a vehicle using sensors is a fundamental challenge in developing algorithms for highly automated and autonomous driving for motor vehicles.

The development of algorithms requires a very large quantity of training data that may be used for training neural networks. Such data is also referred to as “labeled data.” This means that certain information is known for the data, which a neural network should independently detect from comparable data. Such data is needed to train neural networks because information may be incorporated into neural networks using this data.

However, the approaches most commonly used today to create training data that include “labeled data” are usually expensive and time-consuming. Such methods often require manual post-processing and classification of data. According to other approaches, very precise reference measurements are required with complex (other) sensor installations that are installed on a test vehicle. Generally, the amount of suitable data that may be acquired using such methods is limited. It may be assumed that the limited availability of appropriate training data is one of the most relevant reasons blocking the development of highly automated and autonomous driving functions for motor vehicles.

Novel techniques are known in which drones may be used to help acquire training data much more efficiently. For example, one known approach is to acquire such data with the help of a drone that accompanies a vehicle conducting test drives to acquire data for training neural networks.

Specifically, acquiring training data using drones and test vehicles during test drives comprises the following individual steps of cooperation between the test vehicle and the drone:
1) The test vehicle and its surrounding environment are recorded using a camera installed on the drone during the test drive and provided as video data.
2) The test vehicle and other relevant objects in the surrounding environment are identified in the video data.
3) The temporal and spatial positions of the objects and the test vehicle in a coordinate system are determined. In particular, the positions of the objects and the test vehicle are determined in a vehicle coordinate system, which preferably moves with the test vehicle during the test drive.

Creating high-precision reference data using video data recorded with the camera of a drone flying over a test vehicle requires precise spatial and temporal synchronization of the coordinate systems of the drone and test vehicle. Data processing in the test vehicle and the drone may cause temporal and spatial delays or shifts that make it difficult to link data created with cameras on the drone and data acquired from environmental sensors on the vehicle.

Temporal and spatial synchronization between the test vehicle and the drone should meet the following requirements
High precision;
Low cost;
As little additional measurement equipment as possible or no additional measurement equipment in the drone; and
As little additional measurement equipment as possible or no additional measurement equipment in the test vehicle;
Minimal impact of environmental conditions and/or geographic conditions on the possibility and accuracy of time synchronization

### SUMMARY

Based on this, the object of the present disclosure is to at least partially resolve the problems described with reference to the prior art. This object is achieved with the disclosure according to the features set forth below. Further advantageous configurations are specified in the general description and in particular also in the description of the figures. It should be noted that the skilled person may combine the individual features together in a technologically sensible manner and thus arrive at further configurations of the disclosure.

A method for calibrating the position of a marking on a vehicle which is suitable for detecting the position of the vehicle in video data is to be described herein, comprising the following steps:
a) Applying the marking to the vehicle;
b) Applying test markers on both sides of a rear axle of the vehicle;
c) Creating at least one image of the vehicle with the marking and the test markers;
d) Detecting the position of the test markers in a coordinate system based on the at least one image;
e) Detecting the position of the marking in the coordinate system based on the at least one image; and
f) Calculating the relative position of the marking to the test markers.

In the disclosure discussed here, the focus is on the spatial synchronization of coordinate systems of the test vehicle and the drone. Data determined by environmental sensors of the test vehicle related to objects in the surrounding vicinity of the test vehicle are regularly present in a coordinate system that is predetermined originating from the test vehicle. The video data recorded by the drone's camera is present in a coordinate system that originates from or is predetermined by the drone. The synchronization of these two coordinate systems is required to enhance or label the data acquired by the test vehicle's environmental sensors using information from the video data recorded by the drone's camera.

The solution to achieve spatial synchronization is to use markers on the test vehicle that are detectable in the video data recorded by the drone's camera. Using such markers, it is possible to detect the relative position and relative orientation of the drone and the test vehicle to one other.

Markers or markings are applied to the test vehicle to perform test drives with vehicles accompanied by a drone. Markers or markings are regularly mounted by hand. Inaccuracies may thus arise during mounting, however these may be of great importance for detecting the alignment and/or position of the vehicle. In video data recorded with a drone's camera, the markings are detected, and the alignment and/or position of the vehicle in the video data is determined based on these markings. Even minor errors in mounting the marking may cause significant inaccuracies in the determined alignment and/or position of the vehicle in the video data.

Provided that a temporal synchronization of the coordinate systems of the drone and test vehicle is accurate, the calibration of markers or markings on the test vehicle for detecting spatial orientation/alignment essentially requires two subtasks:
(1) The calibration of the relative position and orientation of the markers on the test vehicle in the coordinate system of the test vehicle; and
(2) The calibration of the relative position and orientation of the relevant objects to the markers on the test vehicle.

In general, such calibration may be carried out in various ways. However, a particularly efficient approach is proposed here.

The marker for continuous spatial synchronization of the video data recorded by the drone's camera and the test vehicle is typically large and mounted on the roof of the test vehicle. Here, it is now proposed to temporarily apply smaller test markers with a known geometry to both sides of the rear axle of the test vehicle for the calibration of this (main) marker. A photo is then taken with a drone from above, in which the test markers and the main marker are visible. A calibration algorithm is then performed corresponding to steps c) to f).

The rear axle of a vehicle is always aligned precisely perpendicular with the longitudinal axis of the vehicle due to its construction. Wheels of the vehicle on the rear axle, and in particular rims, are rotationally symmetrical. A precisely centered position on the wheels may be found using suitable devices that evenly encompass the wheels from all directions or engage with rims on the wheels. Thus, it is possible to apply markers with little effort to the rear axle, which precisely mark the extensions of the rear axle in both directions. Significantly fewer work steps that must be carried out accurately are required to position suitable markers accurately on the rear axle than are required to position a large marker on the roof of the vehicle.

It is particularly preferable if the video data and/or the at least one image made in step c) are created with a camera mounted on a drone, with which the vehicle is observed from a monitoring position located above the vehicle.

In design variants of the method, multiple images may also be created from different positions in step c). Preferably, multiple images are then also used to detect the markers and markings in steps d) and e). Particularly preferably, the calculation of the relative position in step f) is also performed with multiple images. It is possible that only a subset of the images created in step c) is used to perform steps d), e) and f) respectively. For example, the method may be configured to select a subset of images from a first quantity of images created in step c) that is particularly well-suited for performing steps d), e) and/or f).

Moreover, it is preferable if the marking is applied to the roof of the vehicle.

Particularly preferably, a roof rack system exists on the vehicle to which the marking may be applied. The marking is preferably applied to a large panel. The assembly of the marking is thus essentially assembling the panel on the vehicle. When assembling such a panel with a marking on the vehicle, assembly inaccuracies may occur. The described method may increase the error tolerance when assembling such a panel, because the test markers applied in step b) may determine a relative positioning of the marking to the rear axle of the vehicle. This relative positioning may be stored and, based on the markings applied in step a), a determined position of the vehicle in video data may then be corrected with this relative positioning.

Such a marking is best visible on the roof for a drone that accompanies a vehicle in flight, and vehicle sensors are least affected by the marking in this position. In principle, other positions are also possible, for example on a vehicle's hood.

It is further preferable if the marking is formed from a plurality of individual marking elements.

In design variants of the method, it is also possible for the marking on the roof to be composed of a plurality of individual markings. These individual markings or marking elements can, for example, be applied to the roof separately. In design variants, the individual markings and marking elements are, for example, stickers that have been applied to the roof or other areas of the vehicle visible from above.

In this context, it is particularly preferred if, in step f), an additional structure of the marking is detected, which is suitable for later detection of a spatial alignment of the vehicle.

Such markings, composed of individual markings or marking elements, are not as precise in their structure as a marking that has been applied to the roof in one piece (e.g., on a panel). For example, if individual markings have been applied to the roof of a vehicle by a person, an exact alignment of the individual markings with respect to one another cannot be assumed. Detection of a vehicle's alignment based on such a marking therefore requires additional information about the marking's structure. The structure of the marking refers here in particular to the alignment and arrangement of individual markings/marking elements in relation to one another.

It is advantageous to additionally determine such a structure of the marking in step f), and in particular to determine the relative alignment of this structure to the test markers.

Moreover, it is preferable if the marking is formed with a regular pattern of marking elements.

Additionally, it is preferable if the test markers comprise ArUco markers.

In general, all types of markers which are detectable in a camera image taken with a camera on the drone may be used as test markers on the rear axle.

However, it is proposed here to use so-called ArUco markers as test markers on the rear axle. An ArUco marker is a marker that has a black border and an inner binary matrix of squares that are partially white and partially black and that identify the marker. The black edge or black border simplifies the quick detection of the marker. The size of an ArUco marker is defined by the number of squares, which may be either white or black. 4×4 markers may be used, for example, which thus include 16 bits of information.

In general, the problem exists that a marker may be detected in four different alignments. Preferably, the black or white squares of the marker are designed such that, regardless of the orientation, the data detectable in the marker is the same. As a result, some bits of information that may be deposited in such a marker are lost. The special feature of ArUco markers is that the alignment of the marker is not relevant for the evaluation of the black and white areas of the marker as bits. This is a clear advantage for the markers used on the rear axle in the method described here. The assembly of the markers on the rear axle is further simplified for the assembler because they do not have to take the alignment of the markers into account.

Moreover, is preferred if the test markers are removed after step c).

In addition, the method is advantageous if a relative position of the marking calculated in step f) and/or a structure of the marking detected in step f) for determining a position and/or orientation of the vehicle is provided using the marking. Preferably, the relative position or the detected structure of the marking is stored in a memory and used in the later processing of video data generated with a drone in which the vehicle with the marking is visible.

An assembly kit for mounting test markers in a rear axle symmetrical manner on any shape of rims on the rear axle of a motor vehicle is also to be described here, wherein the assembly kit is provided for performing the described method.

Such an assembly kit may comprise, for example, two clip systems and/or jaw systems, which allow markings to be assembled respectively in an axially symmetrical manner with the rear axle on wheels or rims of the vehicle. Particularly preferably, the assembly kit comprises test markers that are designed with components (e.g., the jaws or clips described) that allow or simplify assembly on the rear axle. The assembly kit simplifies assembly of the test markers aligned with the rear axle. In particular, the assembly kit or the components of the assembly kit are designed so that the test markers are automatically aligned with the rear axle during assembly. Rear axle symmetrical, in particular, means that the test markers are in a position that is precisely aligned relative to the rear axle and that this alignment is also the same on both sides of the rear axle.

### BRIEF DESCRIPTION OF THE DRAWINGS

The technical environment of the disclosure is explained in more detail below on the basis of the figures. The figures show preferred exemplary embodiments to which the disclosure is not limited. It should in particular be noted that the figures and in particular the size relationships shown in the figures are merely schematic. The figures show:

FIG. 1: a schematic illustration of a drone monitoring a vehicle;

FIG. 2: a vehicle having test markers for performing the method described here;

FIG. 3a to FIG. 3g: different ArUco markers for test markers for performing the described method.

### DETAILED DESCRIPTION

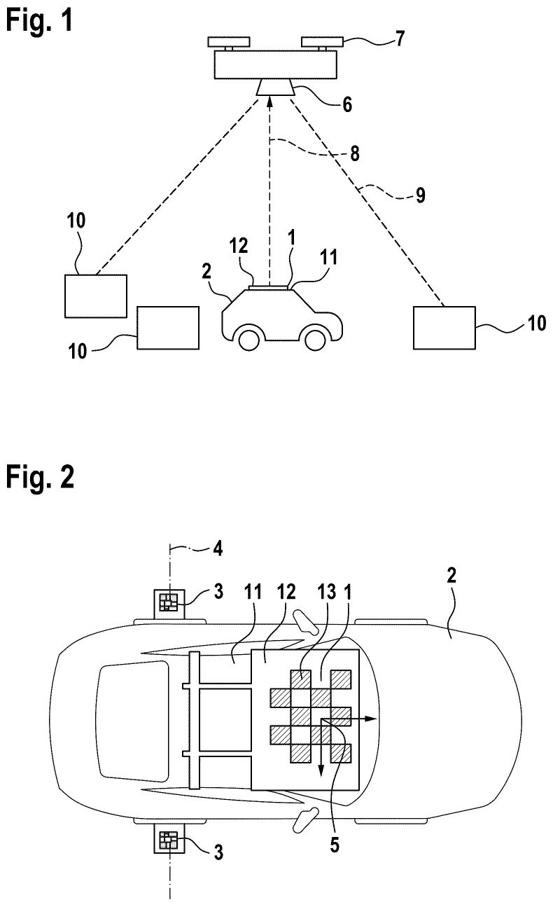

FIG. 1 shows a schematic illustration of a drone 7 accompanying a vehicle 2 and monitoring the vehicle from a monitoring position 8 above the vehicle 2. The drone 7 has a camera 6 with a downward-oriented field of view 9 that may be used to generate camera data or video data in which the vehicle 2 and other objects 10 in the surrounding vicinity of the vehicle 2 are detectable/visible. A panel 12 with a marking 1 is provided on the roof 11 of the vehicle 2 which is detectable in camera data or video data recorded by the drone 7, and which is used to help determine the position and alignment of the vehicle 2 in the video data or camera data. For this to work, it is important that the marking 1 is positioned exactly on the vehicle 2 or its roof 11, or that the alignment of the marking 1 is at least precisely known.

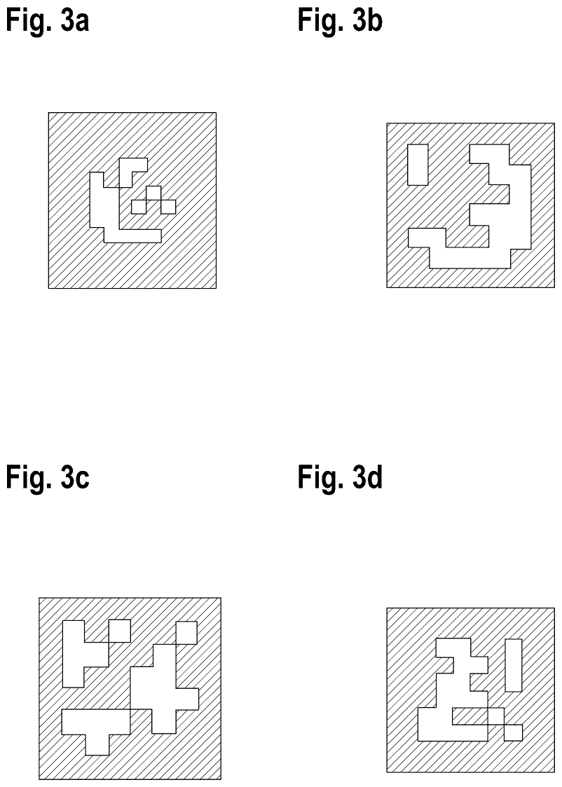

FIG. 2 shows how the alignment and position of the marking 1 on the roof 11 of a vehicle 2 may be determined very precisely in a coordinate system 5. The marking 1 is located on a panel 12 that is mounted on the roof 11 of the vehicle 2 with a fastening system. The marking 1 is also shown here even more precisely. The marking 1 preferably consists of a plurality of marking elements 13, which may be detected together in the video data or camera data recorded by the camera of a drone and which may be used to detect an alignment, orientation and/or position.

The rear axle 4 represents a fixed orientation to a vehicle 2 because this axle is usually rigid, meaning it is not steered. The alignment of the rear axle 4 is typically exactly 90° to the longitudinal direction of the vehicle 2. In the described method, test markers 3 are preferably applied to the rear axle 4, which are also detectable in video data or camera data. In camera data, the position of the marking 1 relative to the test markers 3 may be determined. The position of the marking 1 relative to the rear axle 4 and thus also relative to the longitudinal direction of vehicle 2 may be precisely determined.

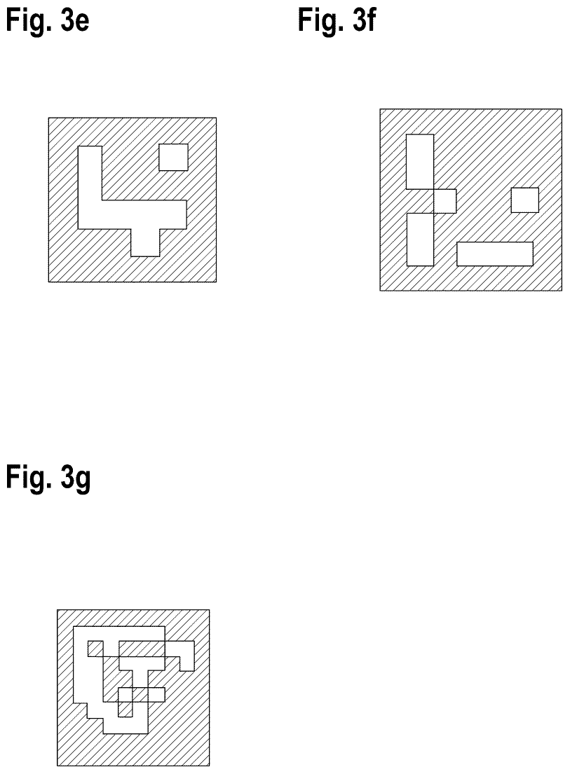

FIGS. 3a to 3g show examples of various ArUco markers for test markers 3 to perform the described method.

What is claimed is:

1. A method for calibrating the position of a marking on a vehicle suitable for detecting the position of the vehicle in video data, the method comprising:
a) applying the marking to the vehicle;
b) applying test markers on both sides of a rear axle of the vehicle;
c) creating at least one image of the vehicle with the marking and the test markers;
d) detecting the position of the test markers in a coordinate system based on the at least one image;
e) detecting the position of the marking in the coordinate system based on the at least one image; and
f) calculating the relative position of the marking to the test markers.

2. The method according to claim 1, wherein the video data and/or the images made in step c) are created with a camera mounted on a drone, which is used to monitor the vehicle from a monitoring position located above the vehicle.

3. The method according to claim 1, wherein the marking is applied to the roof of the vehicle.

4. The method according to claim 1, wherein the marking is formed with a regular pattern of marking elements.

5. The method according to claim 1, wherein the marking is formed from a plurality of individual marking elements.

6. The method according to claim 1, wherein in step f), a structure of the marking is additionally detected, which is suitable for later detection of a spatial alignment of the vehicle.

7. The method according to claim 1, wherein the test markers comprise ArUco markers.

8. The method according to claim 1, wherein the test markers are removed after step c).

9. The method according to claim 1, wherein a relative position of the marking calculated in step f) and/or a structure of the marking detected in step f) is provided for determining a position and/or orientation of the vehicle using the marking.

10. An assembly kit for rear axle symmetrical attachment of test markers to any shape of rims on the rear axle of a motor vehicle for performing the method according to claim 1.
